(19) United States
(12) Patent Application Publication
(10) Pub. No.: US 2004/0053420 A1
(43) Pub. Date: Mar. 18, 2004

(54) Method for measuring the concentration of impurities in helium by ion mobility spectrometry

(75) Inventors: Luca Pusterla, Milano (IT); Marco Succi, Milano (IT); Antonio Bonucci, Milano (IT); Robert Stimac, Palm Beach Gardens, FL (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/601,383

(22) Filed: Jun. 23, 2003

Related U.S. Application Data
(63) Continuation of application No. PCT/IT02/00004, filed on Jan. 8, 2002.

(30) Foreign Application Priority Data
Jan. 8, 2001 (IT) MI2001A 000018

(51) Int. Cl. G01N 21/62

(52) U.S. Cl. 436/171

(57) ABSTRACT

A method for the quantitative analysis of the concentration of impurities in helium by means of ion mobility spectrometry is described, which consists in using purified argon together with the helium which has to be analyzed for forming the sample, or pure argon as counterflow gas in the separation zone of the instrument, or finally helium-purified argon mixtures both for the sample gas and for the counterflow gas.

### CROSS-REFERENCE TO RELATED APPLICATIONS

This application is a continuation of International Application No. PCT/ITO2/00004, filed Jan. 8, 2002, which was published in the English language on Jul. 11, 2002, under International Publication No. WO 02/054058 A1 and the disclosure of which is incorporated herein by reference.

### BACKGROUND OF THE INVENTION

The present invention relates to a method for measuring the concentration of impurities in helium by means of ion mobility spectrometry.

Helium is widely used as a reaction medium or as a transport gas in the integrated circuits industry. As known, in the production of these devices the purity of all the reagents used is fundamentally important. As a matter of fact, contaminants possibly present in the reagents or in the reaction environment can be incorporated in the solid state devices, thus altering the electrical properties thereof and giving rise to production wastes. The specifications on the purity of the gases employed in production can vary from one manufacturer to another, and depending on the particular process employed. Generally, a gas is considered to be acceptable for production when its content in impurities is lower than 10 ppb (parts per billion). Preferably, the content in impurities is less than 1 ppb. As a result, it is important to be able to measure extremely low concentrations of impurities in the gases in a precise and reproducible way.

A technique that can be used for this purpose is ion mobility spectrometry, known in the field with the abbreviation IMS. The same abbreviation is used also for the instrument with which the technique is carried out, indicating in this case “Ion Mobility Spectrometer”. The interest for this technique derives from its very high sensitivity, associated with limited size and cost of the instrument. By operating in appropriate conditions, it is possible to sense species in the gas or vapor phase in a gas medium in quantities on the order of picograms (pg, that is 10⁻¹² grams), or in concentrations on the order of parts per trillion (ppt, equivalent to a molecule of analyzed substance for every 10¹² gas molecules of the sample). IMS instruments and methods of analysis in which they are employed are described, for example, in U.S. Pat. Nos. 5,457,316 and 5,955,886 in the name of U.S. company PCP Inc.

An IMS instrument is essentially formed of a reaction zone, a separation zone and a collector of charged particles.

In the reaction zone takes place the ionization of the sample comprising the gases or vapors to be analyzed in a transport gas, commonly by means of beta-radiation emitted by ⁶³Ni. The ionization takes place mainly on the transport gases with formation of the so-called “reagent ions,” whose charge is then distributed on the present species as a function of their electronic or proton affinities or of their ionization potentials.

The reaction zone is divided from the separation zone by a grid that, when kept at a suitable potential, prevents the ions produced in the reaction zone from entering into the separation zone. The moment when the grid potential is annulled, thus allowing the ions to enter into the separation zone, is the “time zero” of the analysis.

The separation zone comprises a series of electrodes which create an electric field, such that the ions are carried from the reaction zone toward a collector. In this zone, which is kept at atmospheric pressure, a gas flow having an opposite direction with respect to that of the ion movement is present. Commonly, the counterflow gas (defined in the field as “drift gas”) is an extremely pure gas, corresponding to the gas whose content of impurities is to be determined. The velocity of motion of the ions depends on the electric field and on the cross-section of the same ions in the gaseous medium, so that different ions take different times for crossing the separation zone and reaching the particle collector. The time passed from time zero to the time of arrival on the particle collector is called “time of flight.” The collector is connected to the signal processing system, which transforms the current values sensed as a function of time in the final graph, where peaks corresponding to the various ions as a function of the time of flight are shown. From the determination of this time, knowing the test conditions, it is possible to determine the presence of the substances which are objects of the analysis, whereas from the peak areas with suitable computation algorithms it is possible to calculate the concentration of the corresponding species.

In spite of its conceptual simplicity, the application of the technique involves considerable difficulties in the interpretation of the analysis results. This is due first to the fact that the net charge distribution among the various present species is the result of equilibria which depend on various factors, with the result that the peaks corresponding to one impurity can be modified in intensity, or even disappear, depending on the presence of other impurities. The book “Ion Mobility Spectrometry” by G. A. Eiceman and Z. Karpas, published in 1994 by CRC Press, can be referred to for an illustration of the (rather complex) charge transfer principles which are the base of the technique. Further, with equal chemical composition of the gas, the result depends on the analysis parameters, such as the electric field applied in the separation zone, the flow rate of the gas which is to be analyzed and the flow rate of the drift gas.

As a consequence of these phenomena, the shape of the graph resulting from an IMS analysis is strongly dependent on the analysis conditions. The computation algorithms used for interpreting the analysis results are based on the deconvolution of the complete graph and on the relative measure of the areas of all of the peaks present. The best results are obtained when each present ionic species gives rise to a separate peak in the graph. The analysis is still possible, although with greater difficulties, when some peaks are superimposed. In these cases it is necessary to resort to hypotheses of repartition of the peak areas among the different species, with the risk anyway of introducing errors in the analysis. Finally, the IMS analysis (also the qualitative one) is impossible when large superimpositions between peaks corresponding-to different species are present.

Because of the complexity of the phenomena in play, there is no standard method for applying the IMS technique, and each analysis has to be studied separately, in order to define the conditions which allow obtaining a good separation of all the peaks corresponding to the different species which can be present in the gas under analysis.

### BRIEF SUMMARY OF THE INVENTION

An object of the present invention is to provide a method for measuring the concentration of impurities in helium by ion mobility spectrometry.

This object is obtained according to the present invention by a method which consists in carrying out the analysis under one of the following conditions:

employing as the sample gas a helium-argon mixture formed of the helium whose content of impurities is to be determined and pure argon, the mixture containing from 0.1 to 50% of argon, and pure helium as the counterflow gas in the separation zone of the ion mobility spectrometer; or

employing as the sample gas the helium whose impurities content is to be determined or a mixture thereof with pure argon, the mixture containing from 0.1 to 50% of argon, and pure argon as the counterflow gas in the separation zone of the ion mobility spectrometer; or

employing as the sample gas a mixture between the helium whose content of impurities is to be determined and pure argon and as the counterflow gas a helium-argon mixture containing no impurities, wherein the mixtures have an argon concentration included between 10 and 80%.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram of a possible system for forming helium-argon mixtures suitable for the analysis according to the invention; and

FIGS. 2 to 6 are graphs showing the results of IMS analyses carried out according to the invention and of analyses carried out in conditions which are not according to the invention.

### DETAILED DESCRIPTION OF THE INVENTION

The standard way to carry out an IMS analysis requires the use, as the drift gas, of the same gas (obviously pure) as the main gas in the sample whose impurity content is to be determined.

In contrast, the inventors have found that, in the case of the analysis of impurities in helium, only operating according to one of the above mentioned conditions allows one to obtain graphs where the peaks corresponding to the various impurities are sufficiently separated, thus allowing a reliable quantitative analysis as previously discussed.

Obviously, in all the conditions of analysis according to the invention, the only impure gas used is helium whose content of impurities is to be determined, whereas all the other gases (the argon of the sample gas or the drift gas) must be pure, in order not to introduce impurities which would modify the result of the analysis.

The first possibility of operation according to the invention consists in using pure helium as drift gas and, as sample gas, a mixture of argon and the helium whose content of impurities is to be determined, the mixture containing from 0.1 to 50% of argon.

In this condition the effect of argon, which is present as the minor component of the sample mixture, is essentially to improve the ionization processes, thus allowing the formation and the detection of the peaks corresponding to the impurities.

When operating according to this first condition, the ratio between the flow of the sample gas and the drift gas is not critical and can be anything, as long as the extreme is not reached of an excessive dilution of the sample gas which would reduce the sensitivity of the method of analysis.

In the second operative condition according to the invention, the helium whose content of impurities is to be determined or a mixture thereof with argon is used as the sample gas, and pure argon is used as the drift gas. Also, in this case the possible sample mixture contains from 0.1 to 50% of argon.

By operating according to this second condition, it is preferable that the flow rate of the drift gas (also indicated in the following as F_{d}) is at least ten times higher than the flow rate of the sample gas (also indicated in the following as F_{c}). Even more preferably, the ratio F_{d}/F_{c} is included between about 15 and 20. By operating with values of the ratio F_{d}/F_{c} lower than 10, a poor separation of the peaks corresponding to the impurities is obtained, whereas by operating with too high values of the ratio, for example higher than 20, an excessive dilution of the sample occurs, to the detriment of the analysis sensitivity.

Finally, according to the last operative condition of the invention, the sample gas and the drift gas are two helium-argon mixtures having an argon concentration comprised between 10 and 80%. At lower values the separation of the peaks corresponding to the various species is not sufficient for the purposes of the quantitative analysis, whereas at higher values the quantity of helium in the sample gas is excessively reduced and a poor sensitivity of the analysis results. Inside this range, the best results are obtained with argon concentrations comprised between about 30 and 40% of the mixtures.

In this case the ratio between the flow rates of sample gas and drift gas is not relevant for the results, and is generally maintained at values of about 1:2.

The helium/argon mixtures used in this operative condition can be prepared by mixing pure argon with the helium which is to be analyzed (in the case of the sample gas) or with pure helium (in the case of the drift gas) by any mixing system. For example, it is possible to employ calibration systems based on the use of mass flowmeters, or systems comprising narrowings having a calibrated and known gas conductance, such as the system described in Italian patent application MI2000A-002708 in the name of SAES Getters S.p.A. The mixture to be employed as the drift gas can also be found on the market from the companies which sell the pure gases. The sample mixture and the one to be employed as the drift gas do not need to have the same argon concentration. This can, however, be a preferred condition, because it requires a lower number of controls on the system for mixing the gas flows.

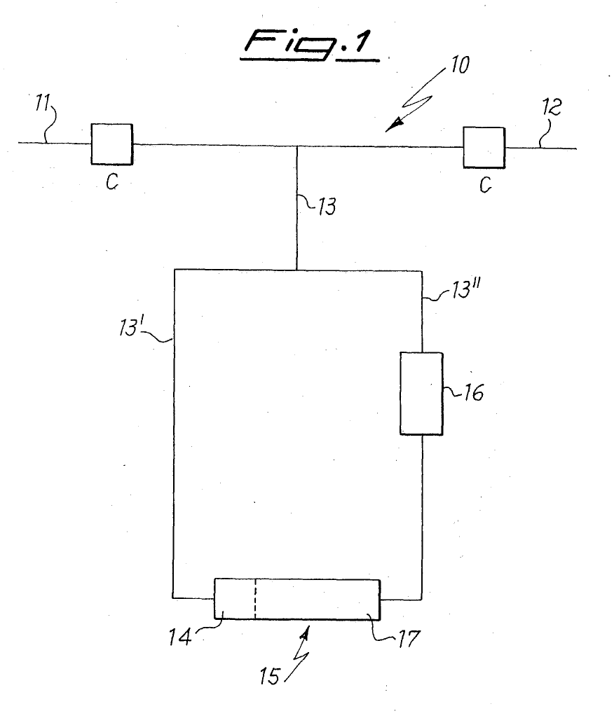

It is also possible that the sample gas and the drift gas are formed starting from the same mixture. For carrying out this embodiment it is possible to employ the system schematically shown in FIG. 1. In the system 10 a helium flow containing impurities coming from a line 11 is mixed with a flow of pure argon coming from a line 12. The desired mixing ratio (for example, He:Ar=50:50) is obtained by means of flow rate control elements which are generally indicated as C. The mixture is formed in line 13, which is subsequently divided into two secondary lines 13′ and 13″. The portion of the mixture in line 13′ (containing the impurities initially present in the helium) is sent without further treatments to the reaction zone 14 of an IMS instrument 15. The portion of the mixture in line 13″ is sent to a purification system 16, which removes all of the impurities present in the mixture, and subsequently to the separation zone 17 of instrument 15, forming the drift gas of the analysis.

The purification system may be formed of one or more purifiers in series. The purifiers can be, for example, of the kind comprising getter alloys, generally based on zirconium or titanium, kept at temperatures comprised between about 250 and 500° C. Purifiers which employ getter alloys are the object of various patent publications including, for example, U.S. Pat. Nos. 4,942,019; 5,080,875; 5,182,0899; 5,238,469; 5,492,682; 5,556,603; 5,558,844; 5,968,468; and 6,086,685 and European Patents EP-B-0 470 936; EP-B-0 484 301 and EP-B-0 493 347. Alternatively, purifiers working at ambient temperature can be used, such as the purifiers based on nickel generally dispersed on highly porous supports, such as zeolites or alumina, which are able to sorb a wide range of gases, in particular water, oxygen, carbon monoxide, carbon dioxide, and hydrogen. The purifiers based on nickel are preferably used in combination with catalytic materials for the conversion of some gases in species which can be more easily sorbed. For example, it is possible to use a bed of palladium oxide kept at a temperature comprised between about 200 and 400° C., which is able to convert methane into carbon dioxide and water, which are then sorbed by the supported nickel metal. It is then possible to use purifiers specific for some kind of gases, for example the purifier for removing oxygenated species from ammonia described in U.S. Pat. No. 5,716,588, or the purifier selective for water described in European published patent application EP-A-0 960 647. These specific purifiers are generally employed in combination with a purifier which is able to remove several gases of the previously described types. Finally, the purifiers described up to now may be used in combination With purifiers comprising other materials capable of physically sorbing gases at room temperature, for example molecular sieves, which can remove part of the water or some hydrocarbons, thus prolonging the life of the principal purifier.

The invention will be further illustrated by the following examples.

The test results are given in graphs where peaks are present as a function of the time of flight of the corresponding ions in milliseconds (ms). The peaks have an area corresponding to the concentration of the different ions. These ions are generally complex species, which may comprise one or more molecules of the ionized gas, possibly associated to more neutral molecules of the transport gas: for the sake of simplicity, the main peaks in the Figures are identified with the formula of the molecular species to which they are ascribed, rather than with the formula of the actually corresponding complex ion. The peak intensity is given in volts (V). The transformation of the current directly measured by the detector (the number of ions which collide on the collector in the unit of time) into volts is accomplished by the instrument electronics. The ionization of the sample is carried out by a radioactive source of ⁶³Ni. The separation zone of the employed instrument is 8 cm long. In all the tests the electric field applied is equal to 128 V/cm.

### EXAMPLE 1

This example is representative of the first condition of analysis of the invention.

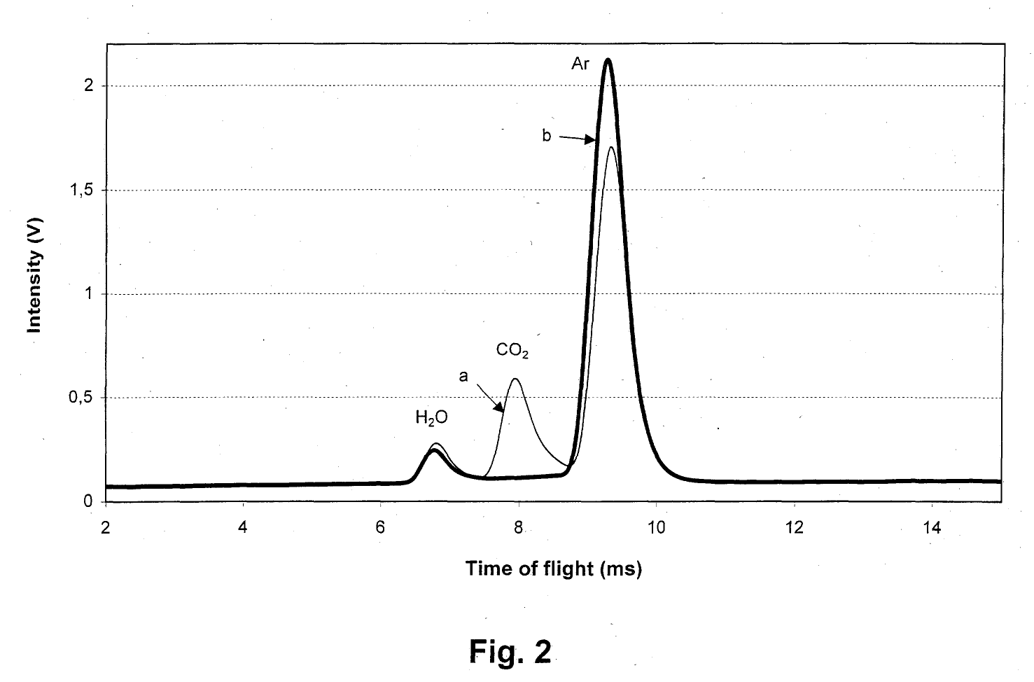

An IMS analysis is carried out on a helium-argon mixture containing 5% of argon to which, with a calibration system based on the use of mass flowmeters, 4 ppb of carbon dioxide (CO₂) are added. The test is carried out at 80° C. by using pure helium as the drift gas; the ratio between the flow rate of the sample gas and that of the drift gas is equal to 1. The test results are given in the graph of FIG. 2 as curve a (thinnest line in FIG. 2). As a comparison, in the Fig. are also given the results of an analysis carried out in the same conditions, but using as the sample an argon-helium mixture to which no CO₂ has been added (curve b, thickest line).

### EXAMPLE 2

This example is representative of the second condition of analysis of the invention.

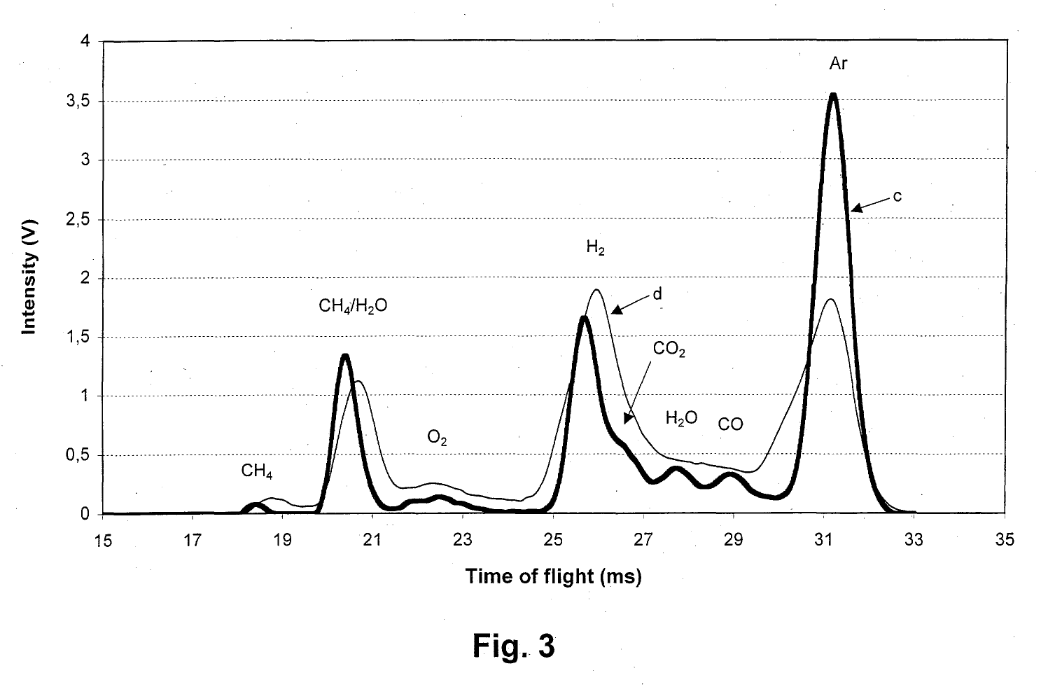

An IMS analysis is carried out on helium containing CO₂, carbon monoxide (CO), oxygen (O₂) and methane (CH₄) as intentionally added impurities, and about 2 ppb of hydrogen (H₂) and 2 ppb of water (H₂O) as “background” impurities of the system, which are hardly eliminatable. The test is carried out at 80° C. using pure argon as the drift gas. The flow rate of the sample gas is equal to 0.25 l/min, and that of the drift gas is equal to 4 l/min, with a ratio F_{d}/F_{c} of 16. The test results are given in the graph in FIG. 3 as curve c (thickest line in FIG. 3).

### EXAMPLE 3

The test of Example 2 is repeated, but operating with a flow rate of drift gas of 2 liters/min and a ratio F_{d}/F_{c} of 8. The result of the test is given in FIG. 3 as curve d (thinnest line in FIG. 3).

### EXAMPLE 4

This example is representative of the second condition of analysis according to the invention.

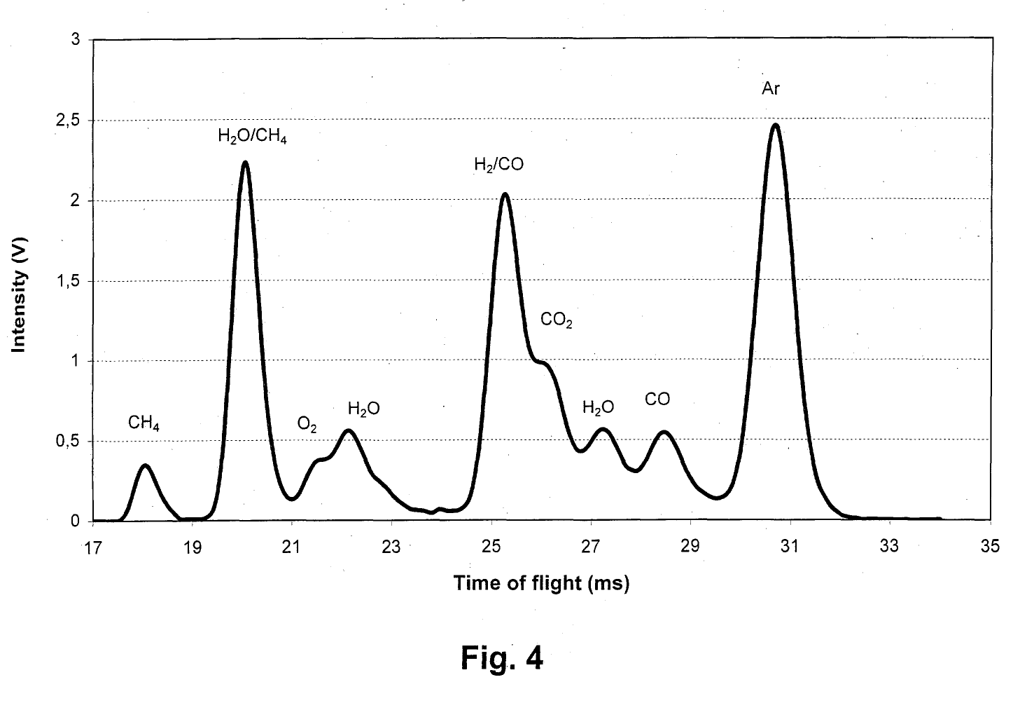

An IMS analysis is carried out using as a sample gas a helium-argon mixture containing 5% of argon, and containing CO, CO₂, O₂ and CH₄ as impurities intentionally added, and H₂ and H₂O as “background” impurities. The test is carried out at 80° C. using pure argon as a drift gas. The flow rate of the sample gas is equal to 0.25 liters/min, and that of the drift gas is 4 liters/min, with a ratio F_{d}/F_{c} of 16. The test results are given in a graph in FIG. 4.

### EXAMPLE 5

This example is representative of the third analysis condition of the invention.

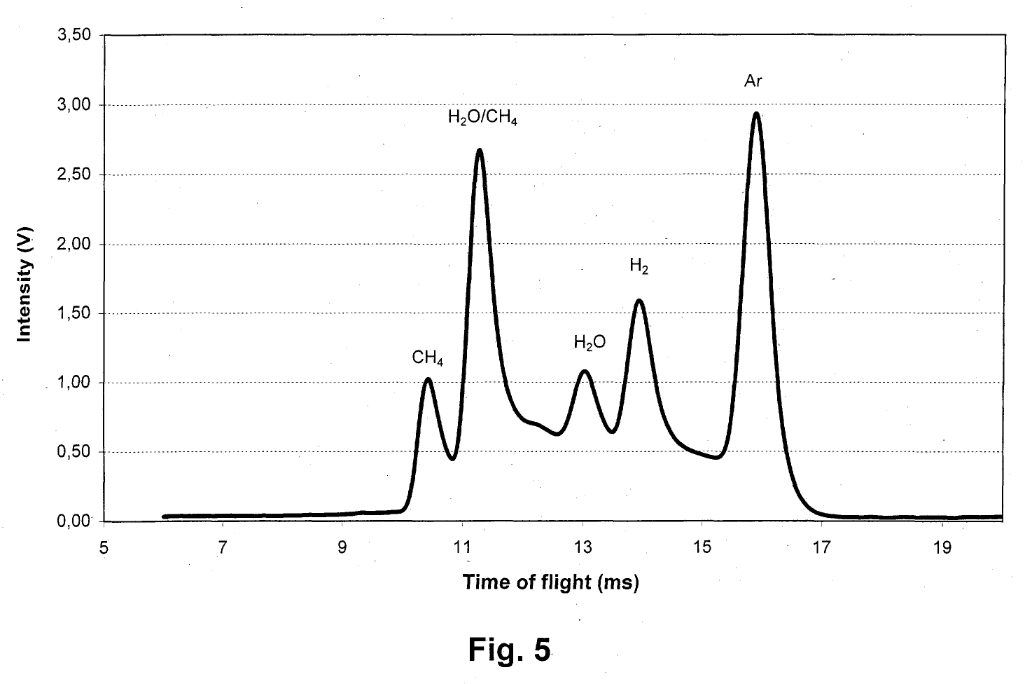

By using a system of gas lines of the type shown in FIG. 1 comprising a nickel-based purifier, two helium-argon mixtures containing 32% of argon are formed. The mixture coming from the line comprising the purifier is employed as a drift gas, whereas the other, containing CH₄ as an intentionally added impurity, and H₂O and H₂ as “background” impurities originally present in the helium, represents the sample gas. The ratio F_{d}/F_{c} is 1. The test results are given in graph in FIG. 5.

### EXAMPLE 6 (COMPARATIVE)

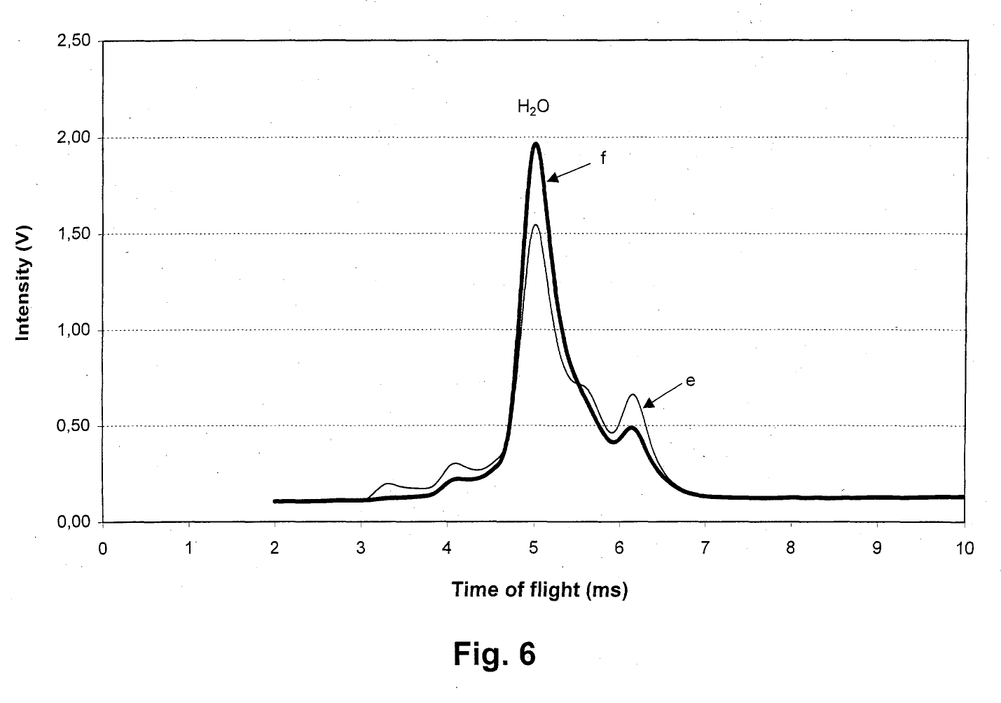

An IMS test is carried out using as a sample gas helium containing as impurities about 2 ppb of H₂O which represent a hardly eliminatable base of the system, and 5 ppb of intentionally added H₂, and pure helium as a drift gas. The test is carried out at 80° C., with a ratio F_{d}/F_{c} of 1. The test results are given in graph in FIG. 6 as curve e (thin curve). The test is then repeated without adding hydrogen (thicker curve, f, in FIG. 6).

As can be noted from the test results, by operating in the various conditions of the invention, it is possible to obtain as a result of IMS analyses graphs wherein the peaks of the different impurities are sufficiently separated. These graphs are thus suitable for allowing the estimation of the areas and therefore the quantitative analysis.

In particular, it can be noted that operating according to the first of the conditions of the invention (Example 1 and FIG. 2), in the case of the presence of the impurity CO₂, this appears as a well defined and recognizable peak.

By operating according to the second condition of the invention (Examples 2-4, FIGS. 3 and 4) it is possible to obtain the separation of the peaks of a number of impurities. In particular, when only helium is used as the sample gas, the best results are obtained with higher ratios between the flow rate of drift gas and sample gas (comparison between curves c and d in FIG. 3).

Finally, operating according to the third of the conditions of the invention (helium-argon mixtures for the sample gas and the drift gas), good results are obtained in terms of separation of the peaks which can be ascribed to the different impurities present.

In contrast, using conditions which are not according to the invention (sample gas formed of helium with impurities and pure helium as the drift gas), in the case that the impurity is hydrogen a spectrum which is hard to interpret is obtained, formed of several peaks which can be difficult to ascribe, so that the calculation of the areas to be assigned to the various species and consequently the quantitative analysis become practically impossible.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for measuring the concentration of impurities in helium gas by ion mobility spectrometry analysis, comprising carrying out the analysis under one of the following conditions:
employing as a sample gas a helium-argon mixture formed of the helium whose concentration of impurities is to be analyzed and pure argon, this mixture containing 0.1 to 50% argon, and pure helium as a counterflow gas in a separation zone of the ion mobility spectrometer; or
employing as the sample gas the helium whose concentration of impurities is to be analyzed or a mixture of this helium with pure argon, this mixture containing 0.1 to 50% of argon, and pure argon as the counterflow gas in the separation zone of the ion mobility spectrometer; or
employing as the sample gas a helium-argon mixture formed of the helium whose concentration of impurities is to be analyzed and pure argon, and as the counterflow gas a helium-argon mixture containing no impurities, wherein these mixtures have an argon concentration of 10 to 80%.

2. The method according to claim 1 wherein, when helium or a helium mixture is used as the sample gas and pure argon is used as the counterflow gas, the ratio of a flowrate of the counterflow gas to a flowrate of the sample gas is at least 10.

3. The method according to claim 2, wherein the ratio is 15 to 20.

4. The method according to claim 1 wherein, when two helium-argon mixtures are used as the sample gas and the counterflow gas, respectively, the two mixtures have an argon concentration of about 30 to 40%.

5. The method according to claim 1 wherein, when two helium-argon mixtures are used as the sample gas and the counterflow gas, respectively, the two mixtures have the same argon concentration.

6. The method according to claim 5, wherein the two mixtures are obtained by using a system (10) wherein a stream of helium containing impurities coming from a line (11) and a stream of pure argon coming from a line (12) are mixed in a line (13), checking the mixing ratio by flow rate control elements (C), subsequently dividing the so obtained gas mixture into two portions conveyed into two secondary lines (13′, 13″), conveying a first portion of the gas mixture in a first secondary line (13′) without further treatment to a reaction zone (14) of the ion mobility spectrometer (15), conveying a second portion of the gas mixture in a second secondary line (13″) to a purification system (16) which removes all impurities present in the second portion, and subsequently conveying the purified second portion as the counterflow gas to the separation zone (17) of the ion mobility spectrometer (15).

7. The method according to claim 6, wherein the purification system (16) comprises a purifier containing getter alloys based on zirconium or titanium.

8. The method according to claim 6, wherein the purification system (16) comprises a purifier based on nickel.

9. The method according to claim 8, wherein the purification system (16) further comprises a catalytic bed of palladium oxide.
